(19) United States
(12) Patent Application Publication
(10) Pub. No.: US 2022/0097915 A1
(43) Pub. Date: Mar. 31, 2022

(54) Lifting Device

(71) Applicant: Jeffry Geier, Farmers Branch, TX (US)

(72) Inventor: Jeffry Geier, Farmers Branch, TX (US)

(21) Appl. No.: 17/032,163

(22) Filed: Sep. 25, 2020

(51) Int. Cl. B65D 25/22; B65D 25/28; B66C 1/62

(52) U.S. Cl. CPC B65D 25/22; B65D 25/2808; B65D 2525/289; B66C 1/625; B65D 2525/285; B65D 25/2817

(57) ABSTRACT

A lifting device for removably attaching handles to an object for lifting thereof includes a first strap having a connector engaged to a first end thereof. The connector is can selectively engage the first strap proximate to a second end thereof. The first strap is can be positioned around a circumference of the object, such as a cooler. The connector is positioned to engage the first strap to removably couple the first strap to the object. A set of handles is engaged to the first strap. A respective handle can be grasped in a hand of a user. The user thus is positioned to exert an upward force upon the object, enabling the user to lift or to tilt the object.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to lifting devices and more particularly pertains to a new lifting device for removably attaching handles to an object for lifting thereof.

### (2) Description of Related Art Including Information Disclosed Under 37 CFR 1.97 and 1.98

The prior art relates to lifting devices. Prior art lifting devices are directed to handles for cylindrical tanks and may comprise a pair of straps or a pair of brackets having a handle extending therebetween, wherein the straps or brackets are configured to be positioned around a cylindrical tank. The prior art also comprises a plate having a handle and a strap engaged thereto, wherein the strap is configured to be positioned around a cylindrical tank. The prior art also comprises a strap having a pair of rigid handles engaged thereto, wherein the strap is configured to be positioned around a cylindrical tank and tightened using a cinch buckle. The prior art also comprises a metallic band having handles engaged thereto, with the metallic band being configured for positioning around and engaging a cylindrical tank. The prior art also comprises a half-cylinder having a handle engaged thereto, with the half-cylinder being configured for inserting and engaging a cylindrical tank. The prior art also comprises a circular strap having handles thereto, wherein the circular strap is configured for insertion of a top of a wheeled cylindrical tank. What is lacking in the prior art is a strap having flexible handles engaged thereto, wherein the strap is configured for positioning around and being secured to an object using a ratcheting buckle.

### BRIEF SUMMARY OF THE INVENTION

An embodiment of the disclosure meets the needs presented above by generally comprising a first strap having a connector engaged to a first end thereof. The connector is configured to selectively engage the first strap proximate to a second end thereof. The first strap is configured to be positioned around a circumference of an object, such as a cooler. The connector is positioned to engage the first strap to removably couple the first strap to the object.

A set of handles is engaged to the first strap. A respective handle is configured to be grasped in a hand of a user. The user thus is positioned to exert an upward force upon the object, enabling the user to lift or to tilt the object.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use view of a lifting device according to an embodiment of the disclosure.

FIG. 2 is an isometric perspective view of an embodiment of the disclosure.

FIG. 3 is a bottom view of an embodiment of the disclosure.

FIG. 4 is a front view of an embodiment of the disclosure.

FIG. 5 is a rear view of an embodiment of the disclosure.

### DETAILED DESCRIPTION OF THE INVENTION

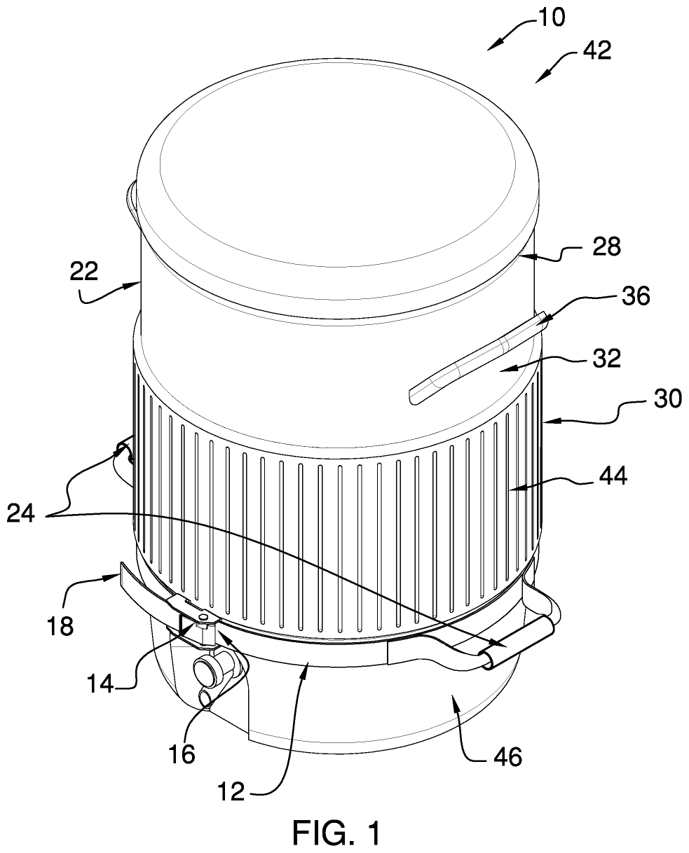

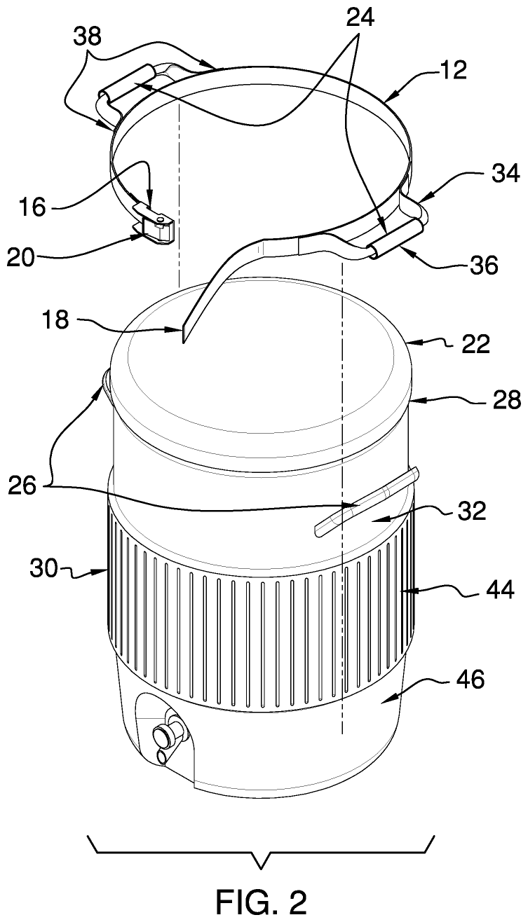

With reference now to the drawings, and in particular to FIGS. 1 through 5 thereof, a new lifting device embodying the principles and concepts of an embodiment of the disclosure and generally designated by the reference numeral 10 will be described.

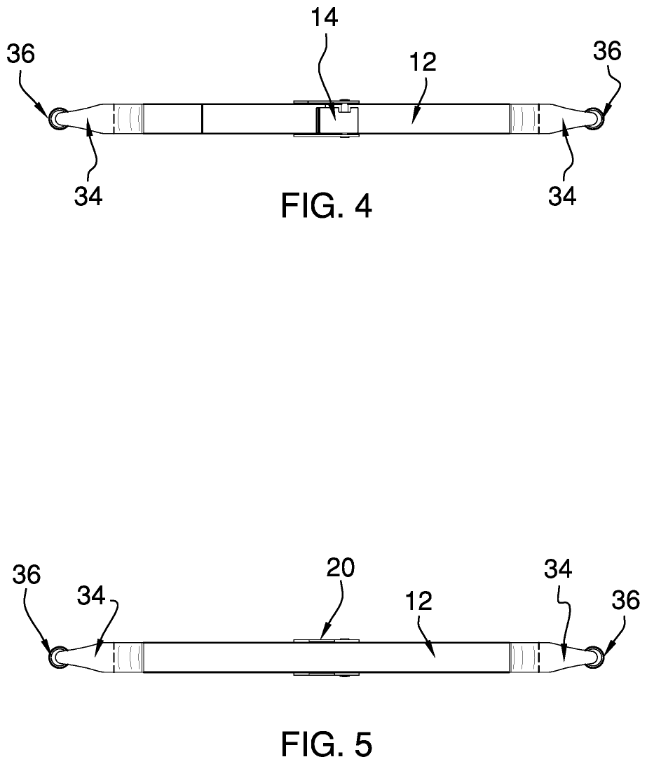

As best illustrated in FIGS. 1 through 5, the lifting device 10 generally comprises a first strap 12 having a connector 14 engaged to a first end 16 thereof. The connector 14 is configured to selectively engage the first strap 12 proximate to a second end 18 thereof. The connector 14 may comprise a ratcheting fastener 20, as shown in FIG. 4, or other connecting means, such as, but not limited to, cam fasteners, over-center fasteners, buckles, and the like.

The first strap 12 is configured to be positioned around a circumference of an object, such as a cooler 22. The connector 14 is positioned to engage the first strap 12 to removably couple the first strap 12 to the object.

A set of handles 24 is engaged to the first strap 12. A respective handle 24 is configured to be grasped in a hand of a user. The user thus is positioned to exert an upward force upon the object, enabling the user to lift or to tilt the object. Some coolers 22 are not equipped with integral handles 26, in which case the device 10 can be affixed to the cooler 22, allowing it to be lifted and tilted. Other coolers 22 have integral handles 26 affixed proximate to a top 28 thereof. Affixing the device 10 to such a cooler 22, below a midpoint 30 thereof, allows a user to lift and to tilt the cooler 22 simultaneously by grasping an integral handle 26 and a handle 24 positioned on the same side 32 of the cooler 22.

The set of handles 24 may comprise two handles 24, or other number of handles, such as one handle 24 or three or more handles 24. For example, a box shaped object could be fitted with a device 10 having four handles 24, with each handle 24 being positioned on a respective side of the box shaped object.

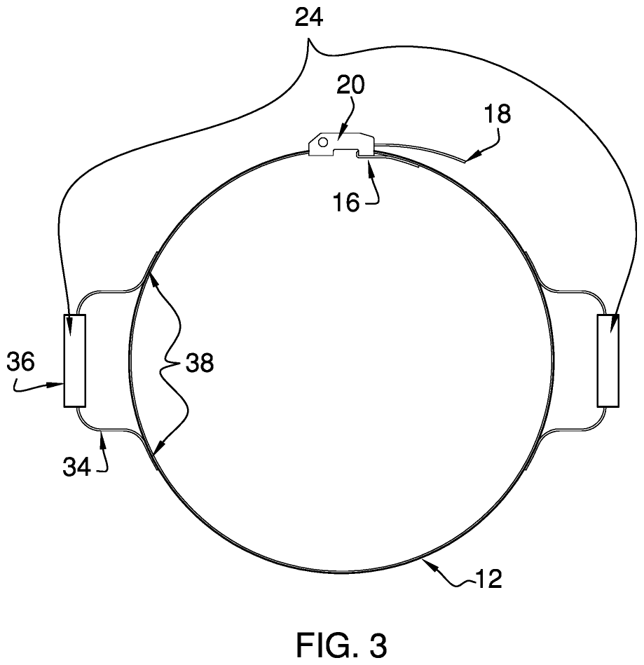

The handles 24 may be fixedly engaged to the first strap 12, as shown in FIG. 3, so that the handles 24 are substantially opposingly positioned on the object upon engagement of the first strap 12 thereto, as shown in FIG. 1. First straps 12 of a variety of lengths can be produced to match objects having a variety of circumferences. The present invention also anticipates the handles 24 being slidably engaged to the first strap 12.

The handle 24 comprises a second strap 34 and a grip 36, as shown in FIG. 3. The second strap 34 has opposed ends 38, which are fixedly engaged to the first strap 12 to define a loop 40. The grip 36 may be slidably engaged or fixedly engaged to the second strap 34. The loop 40 is configured for insertion of digits of a hand of the user. The user thus is positioned to grasp the grip 36 to exert the upward force upon the object. The grip 36 may tubular, with the second strap 34 extending through the grip 36.

The present invention anticipates a lifting device and cooler combination 42. The combination 42 comprises a cooler 22, which may be cylindrically shaped, as shown in FIG. 1. The cooler 22 has a medial section 44 that is circumferentially larger than a lower section 46 thereof. The first strap 12 is positioned around the lower section 46 proximate to the medial section 44. The connector 14 is engaged to the first end 16 and proximate to the second end 18 of the strap so that the first strap 12 is engaged to the cooler 22. The set of handles 24 is engaged to the first strap 12 so that a respective handle 24 is configured to be grasped in a hand of a user. The user is positioned to exert the upward force upon the cooler 22 to lift or to tilt the cooler 22.

In use, the first strap 12 is positioned around the lower section 46 of the cooler 22. The ratcheting fastener 20 is engaged to the first strap 12 and the is ratcheted to tighten the first strap 12 around the cooler 22. The handles 24 are positioned to be grasped in the hand of a user, enabling the user to lift or to tilt the cooler 22.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A lifting device comprising:
a first strap;
a connector engaged to a first end of the first strap and being configured for selectively engaging the first strap proximate to a second end thereof, wherein the first strap is configured for positioning around a circumference of an object, such that the connector is positioned for engaging the first strap for removably coupling the first strap to the cylindrical object; and
a set of handles engaged to the first strap, wherein a respective handle is configured for grasping in a hand of a user, positioning the user for exerting an upward force upon the object.

2. The lifting device of claim 1, wherein the connector comprises a ratcheting fastener.

3. The lifting device of claim 1, wherein the set of handles comprises two handles.

4. The lifting device of claim 1, wherein the handles are fixedly engaged to the first strap, such that the handles are substantially opposingly positioned on the object upon engagement of the first strap thereto.

5. The lifting device of claim 1, wherein the handle comprises a second strap and a grip, the second strap having opposed ends fixedly engaged to the first strap defining a loop, the grip being fixedly engaged to the second strap substantially equally distant from the opposed ends of the second strap, wherein the loop is configured for insertion of digits of a hand of the user, positioning the user for grasping the grip for exerting an upward force upon the object.

6. The lifting device of claim 5, wherein the grip is tubular.

7. The lifting device of claim 1, wherein the handle comprises a second strap and a grip, the second strap having opposed ends fixedly engaged to the first strap defining a loop, the grip being slidably engaged to the second strap, wherein the loop is configured for insertion of digits of a hand of the user, positioning the user for grasping the grip for exerting an upward force upon the object.

8. The lifting device of claim 7, wherein the grip is tubular, the second strap extending through the grip.

9. A lifting device and cooler combination comprising:
a cooler, the cooler having a medial section and a lower section, the medial section being circumferentially larger than the lower section;
a first strap positioned around the lower section proximate to the medial section;
a connector engaged to a first end the strap, the connector being engaged to the first strap proximate to a second end thereof, such that the first strap is engaged to the cooler; and
a set of handles engaged to the first strap, wherein a respective handle is configured for grasping in a hand of a user, positioning the user for exerting an upward force upon the cooler.

10. The lifting device and cooler combination of claim 9, wherein the cooler is cylindrically shaped.

11. The lifting device and cooler combination of claim 9, wherein the connector comprises a ratcheting fastener.

12. The lifting device and cooler combination of claim 9, wherein the set of handles comprises two handles.

13. The lifting device and cooler combination of claim 9, wherein the handles are fixedly engaged to the first strap, such that the handles are substantially opposingly positioned on the cooler.

14. The lifting device of claim 9, wherein the handle comprises a second strap and a grip, the second strap having opposed ends fixedly engaged to the first strap defining a loop, the grip being fixedly engaged to the second strap substantially equally distant from the opposed ends of the second strap, wherein the loop is configured for insertion of digits of a hand of the user, positioning the user for grasping the grip for exerting an upward force upon the cooler.

15. The lifting device and cooler combination of claim 14, wherein the grip is tubular.

16. The lifting device of claim 9, wherein the handle comprises a second strap and a grip, the second strap having opposed ends fixedly engaged to the first strap defining a loop, the grip being slidably engaged to the second strap, wherein the loop is configured for insertion of digits of a hand of the user, positioning the user for grasping the grip for exerting an upward force upon the cooler.

17. The lifting device of claim 6, wherein the grip is tubular, the second strap extending through the grip.

18. A lifting device comprising:
a first strap;
a connector engaged to a first end of the first strap and being configured for selectively engaging the first strap proximate to a second end thereof, wherein the first strap is configured for positioning around a circumference of an object, such that the connector is positioned for engaging the first strap for removably coupling the first strap to the object, the connector comprising a ratcheting fastener; and
a set of handles engaged to the first strap, wherein a respective handle is configured for grasping in a hand of a user, positioning the user for exerting an upward force upon the object, the set of handles comprising two handles, the handles being fixedly engaged to the first strap, such that the handles are substantially opposingly positioned on the object upon engagement of the first strap thereto, the handle comprising a second strap and a grip, the second strap having opposed ends fixedly engaged to the first strap defining a loop, the grip being slidably engaged or fixedly engaged to the second strap, wherein the loop is configured for insertion of digits of a hand of the user, positioning the user for grasping the grip for exerting an upward force upon the object, the grip being tubular, the second strap extending through the grip.
